(19) United States
(12) Patent Application Publication
(10) Pub. No.: US 2014/0236528 A1
(43) Pub. Date: Aug. 21, 2014

(54) MEASUREMENT METHOD FOR JUNCTION-TO-CASE THERMAL RESISTANCE

(71) Applicant: INSTITUTE OF ELECTRICAL ENGINEERING, CHINESE ACADEMY OF SCIENCES, Beijing (CN)

(72) Inventors: ZHIJIE QIU, BEIJING (CN); JIN ZHANG, BEIJING (CN); XUHUI WEN, BEIJING (CN)

(73) Assignee: INSTITUTE OF ELECTRICAL ENGINEERING, CHINESE ACADEMY OF SCIENCES, Beijing (CN)

(21) Appl. No.: 14/055,753

(22) Filed: Oct. 16, 2013

(30) Foreign Application Priority Data
Feb. 20, 2013 (CN) 201310054317.9

(51) Int. Cl. G01K 7/00

(52) U.S. Cl. CPC G01K 7/00
USPC 702/130

(57) ABSTRACT

A measurement method for a junction-to-case thermal resistance is provided. First, a first transient cooling curve of the chip for the semiconductor device under test (DUT) without grease is measured. Then a second transient cooling curve of the chip for the DUT with grease is measured. A difference ΔT of temperature variations of the two transient cooling curves with and without grease is calculated. The temperature of a constant temperature cold plate for fixing the semiconductor DUT is increased by ΔT, and a third transient cooling curve of the chip for the DUT with grease is measured again. The first transient cooling curve and the third transient cooling curve are used to calculate the junction-to-case thermal resistance.

### CROSS-REFERENCE TO RELATED APPLICATIONS

This application claims priority to Chinese Patent Application No. 201310054317.9, filed on Feb. 20, 2013, entitled “Measurement Method for Junction-to-case Thermal Resistance”, which is incorporated herein by reference in its entirety.

### FIELD OF THE TECHNOLOGY

The present invention relates to a method for measuring a junction-to-case thermal resistance, and in particular to a method for measuring a junction-to-case thermal resistance of semiconductor devices.

### BACKGROUND

Junction-to-case thermal resistance is a significant performance parameter which represents the heat dissipation ability of semiconductor devices. Thermal characteristic is a key factor that must be considered during design and application for semiconductor devices. Accurate measurements of junction-to-case thermal resistance have a great value for improving the packaging and thermal design and evaluating the operating limit of devices.

Traditional methods use a temperature-probe monitoring the case temperature of devices. However, the measurement result is lower than the actual case temperature for the temperature difference between the temperature-probe tip and the case surface. Meanwhile, the traditional methods require the location of the temperature-probe directly below the heated chips to measure the maximum case-temperature. But the exact location of the maximum case-temperature is difficult to determine without knowing the number and location of chips. Therefore the junction-to-case thermal resistance is generally overestimated using the traditional measurement methods. In order to solve this problem, the latest JEDEC standard JESD51-14 proposed a transient dual interface test method for the measurement of the junction to case thermal resistance of semiconductor devices with heat flow through a single path. This measurement method requires two transient cooling curve measurements of the same semiconductor device with different contact resistance for cooling the heat sunk package case surface. The first measurement shall be performed without any thermal interface material between the device and the cold-plate. For the second measurement a thin layer of thermal grease shall be applied at the interface. Then two thermal impedance curves may be calculated from the cooling curves with and without thermal grease. Since the cooling path from junction to case remains unchanged and the cooling path from case to ambient changes when the cooling condition at the package case changes, the two thermal impedance curves start to separate from each other at the point of the package case. A separation curve is calculated from two thermal impedance curves and then the junction-to-case thermal resistance shall be determined according to the ε-curve equation ε=0.0045 W/° C.θ_{JC}+0003 given in JESD51-14. Related papers are listed below:
[1] Heinz Pape, Dirk Schweitzer, et al. Development of a Standard for Transient Measurement of Junction-To-Case Thermal Resistance[J].Microelectronics Reliability, 2012,52(7): 1272-1278.
[2] Dirk Schweitzer, Heinz Pape, et al. How to Evaluate Transient Dual Interface Measurements of the Rth-JC of Power Semiconductor Packages[C].Semiconductor Thermal Measurement and Management Symposium, 2009. SEMI-THERM 2009. 25th Annual IEEE, 2009: 172-179.
[3] Dirk Schweitzer, Heinz Pape, et al. Transient Dual Interface Measurement—A New JEDEC Standard for the Measurement of the Junction-to-Case Thermal Resistance[C]. Semiconductor Thermal Measurement and Management Symposium (SEMI-THERM), 2011 27th Annual IEEE, 2011: 222-229.

Compared with the traditional method, the latest measurement method proposed in JESD51-14 provides the junction-to-case thermal resistance of semiconductor devices without measuring the case temperature and therefore avoids errors from the inaccurate case temperature measurement. However, neither JESD51-14 nor papers above have taken into consideration the influence of temperature nonlinearities of packaging materials for measurement. The thermal conductivity and the specific heat capacity of packaging materials are not constant, but change with temperature. Without considering the temperature nonlinearities of packaging materials, the two thermal impedance curves will separate prematurely, which results in a lower thermal resistance than the actual value. Especially for power semiconductor modules such as Insulated Gate Bipolar Transistor (IGBT) which consists of obvious nonlinear packaging materials such as silicon, ceramics and copper, with relatively large area for dissipation and low junction-to-case thermal resistance, the premature separation of thermal impedance curves will lead to a lower valuation even an incorrect one of junction-to-case thermal resistance.

### SUMMARY

An objective of the present invention is to provide a method for measurement of junction-to-case thermal resistance of the chip for the DUT to reduce the errors due to temperature nonlinearities of packaging materials, so as to achieve the goal of more accurate measurement.

The present invention provides a measurement method for a junction-to-case thermal resistance. The method includes the following steps:

1. measuring a first transient cooling curve of a chip for a semiconductor device under test (DUT) without grease;

2. measuring a second transient cooling curve of the chip for the DUT with grease;

3. calculating a difference ΔT between a temperature variation of the first transient cooling curve and a temperature variation of the second transient cooling curve;

4. increasing a temperature of a constant temperature cold plate for fixing the semiconductor DUT by ΔT, and measuring a third transient cooling curve of the chip for the DUT with grease again;

5. calculating the junction-to-case thermal resistance through using the first transient cooling curve and the third transient cooling curve.

Further, calculating the junction-to-case thermal resistance of step 5 includes the following steps:

5.1 calculating a first transient thermal impedance curve according to the first transient cooling curve and a second transient thermal impedance curve according to the third transient cooling curve;

5.2 calculating a separation curve according to the first transient thermal impedance curve and the second transient thermal impedance curve;

5.3 calculating the junction-to-case thermal resistance according to the separation curve through using a separation criterion.

Comparing with existing measurement methods, the present invention can ensure the consistency of the junction-to-case temperature distribution with and without grease when measuring the transient cooling curves. Thus, the premature separation of transient thermal impedance curves caused by temperature nonlinearities of packaging materials may be avoided. A more accurate thermal resistance measurement is obtained.

### BRIEF DESCRIPTION OF THE DRAWINGS

FIG. 1 is a flowchart of a measurement method for junction-to-case thermal resistance according to an implement of the present invention; and

FIG. 2 is a flowchart of a calculation method for junction-to-case thermal resistance according to an implement of the present invention.

### DETAILED DESCRIPTION

The following are further explanation for the present invention combined with drawings and implements.

The measurement method for junction-to-case thermal resistance proposed in the present invention includes the following steps:

(1) measuring a transient cooling curve of the chip for the DUT without grease;

(2) measuring a transient cooling curve of the chip for the DUT with grease;

(3) calculating a difference ΔT of the temperature variations of the transient cooling curves measured in step (1) and step (2);

(4) increasing the temperature of the constant temperature cold plate by ΔT, and measuring a transient cooling curve of the chip for the DUT with grease again; and

(5) calculating the junction-to-case thermal resistance using the transient cooling curves measured in step (1) and step (4).

Further, calculating the junction-to-case thermal resistance of step (5) includes the following steps:

(5.1) calculating transient thermal impedance curves according to the transient cooling curves measured in step (1) and step (4);

(5.2) calculating a separation curve according to the transient thermal impedance curves calculated in step (5.1);

(5.3) calculating the junction-to-case thermal resistance according to the separation curve calculated in step (5.2) using a separation criterion, such as s-curve equation.

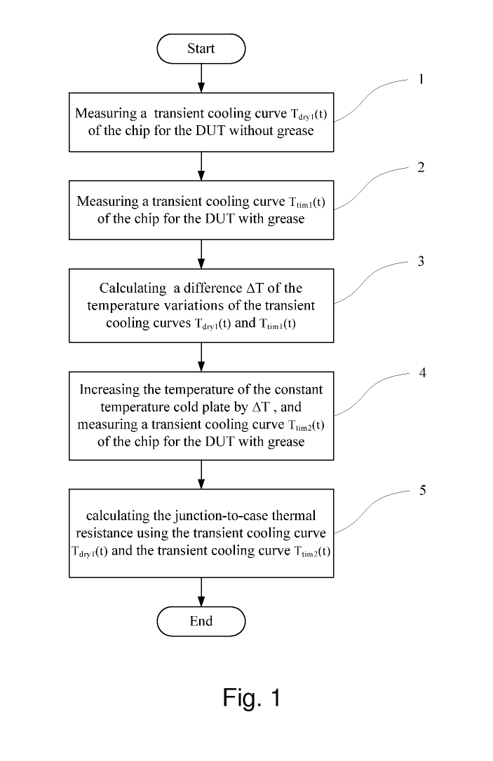

Referring to FIG. 1, the steps of the present measurement method for junction-to-case thermal resistance may be described in detail as follows.

At step 1, the transient cooling curve of the chip for the DUT without grease is measured. The DUT is fixed on the constant temperature cold plate, without grease applied, and the temperature of the constant temperature cold plate is set to T₁. A first heating current I is applied to the chip for the DUT and the heating power is measured as P_{dry}. When reaching a heat balance, the first heating current I is switched off and then the chip for the DUT cools down from a first initial temperature to temperature T₁. A transient cooling curve T_{dry1}(t) of the chip for the DUT is measured for the whole cooling process. The temperature variation for the transient cooling curve T_{dry1}(t) is calculated as ΔT₁.

ΔT₁=the first initial temperature −T₁

At step 2, the transient cooling curve of the chip for the DUT with grease is measured. The temperature of the constant temperature cold plate is maintained at T₁, and grease is applied on the bottom of the DUT. A second heating current I may be applied to the chip for the DUT, which has the same magnitude and duration as the first heating current. When reaching a heat balance, the second heating current I is switched off, and then the chip for the DUT cools down from a second initial temperature to temperature T₁. A transient cooling curve Tₜᵢₘ₁(t) is measured for the whole cooling process. The temperature variation for the transient cooling curve Tₜᵢₘ₁(t) is calculated as ΔT₂.

ΔT₂=the second initial temperature −T₁

At step 3, the difference ΔT of the temperature variations of the two transient cooling curves T_{dry1}(t) and Tₜᵢₘ₁(t) is calculated:

ΔT=ΔT₁−ΔT₂

At step 4, the temperature of the constant temperature cold plate is set to T₂, T₂=T₁+ΔT. A third heating current I is applied to the chip for the DUT and the heating power is measured as Pₜᵢₘ. The third heating current I has the same magnitude and duration as the first heating current. When reaching a heat balance, the third heating current I is switched off, and then the chip for the DUT cools down to T₂. A transient cooling curve Tₜᵢₘ₂(t) is measured for the whole cooling process.

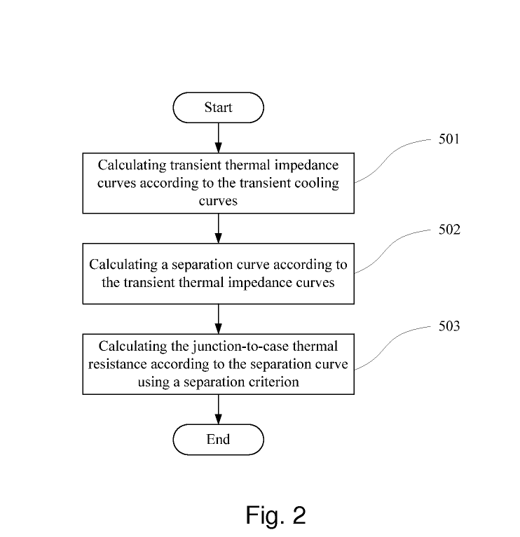

At step 5, the junction-to-case thermal resistance is calculated using the transient cooling curves T_{dry1}(t) and Tₜᵢₘ₂(t) following the steps in FIG. 2.

Referring to FIG. 2, calculating the junction-to-case thermal resistance using the transient cooling curves T_{dry1}(t) and Tₜᵢₘ₂(t) of step 5 includes the following steps.

At step 501, the transient thermal impedance curves are calculated according to the transient cooling curves, following the formulas:

$${Z}_{th - dry} = \frac{{T}_{dry 1} ( t ) - {T}_{1}}{{P}_{dry}} , \\ {Z}_{th - tim} = \frac{{T}_{tim 2} ( t ) - {T}_{2}}{{P}_{tim}}$$

where _{th-dry} is the transient thermal impedance curve without grease;
T_{dry1}(t) is the transient cooling curve without grease;
T₁ is the temperature of the constant temperature cold plate in step 1;
P_{dry} is a heating power in step 1;
Zₜₕ₋ₜᵢₘ is the transient thermal impedance curve with grease;
Tₜᵢₘ₂(t) is the transient cooling curve with grease in step 4;
T₂ is the temperature of the constant temperature cold plate in step 4; and
Pₜᵢₘ is a heating power in step 4.

At step 502, the separation curve is calculated according to the transient thermal impedance curves. The time t is logarithmically transformed, namely letting z=In(t), a(z)=Zₜₕ(t). Then a_{dry}(z)=Z_{th-dry}(t) and aₜᵢₘ(z)=Zₜₕ₋ₜᵢₘ(t) are obtained. The separation curve is expressed as follows:

δ=Δ(da/dz)/Δθ

where Δ(da/dz)=da_{dry}/dz−daₜᵢₘ/dz, δ is the separation function, da_{dry}/dz is a derivative of the transient thermal impedance curve Z_{th-dry} with respect to the logarithmic time z, daₜᵢₘ/dz is a derivative of the transient thermal impedance curve Zₜₕ₋ₜᵢₘ with respect to the logarithmic time z, and Δθ is the difference between steady state thermal resistances with and without grease.

At step 503, the junction-to-case thermal resistance is calculated according to the separation curve using separation criterion (i.e. the ε-curve equation). The intersection of the ε-curve equation ε=0.0045 W/° C.θ_{JC}+0.003 and the separation curve δ=Δ(da/dz)/Δθ gives the value of junction-to-case thermal resistance θ_{JC}.

The present invention provides a measurement method for junction-to-case thermal resistance. The consistency of the junction-to-case temperature distribution with and without grease when measuring the transient cooling curves may be ensured. Thus, the premature separation of transient thermal impedance curves caused by temperature nonlinearities of packaging materials may be avoided. A more accurate thermal resistance measurement is obtained.

What is claimed is:

1. A measurement method for a junction-to-case thermal resistance, comprising:
measuring a first transient cooling curve of a chip for a semiconductor device under test (DUT) without grease;
measuring a second transient cooling curve of the chip for the semiconductor DUT with grease;
calculating a difference ΔT between a temperature variation of the first transient cooling curve and a temperature variation of the second transient cooling curve;
increasing a temperature of a constant temperature cold plate for fixing the semiconductor DUT by the difference ΔT, and measuring a third transient cooling curve of the chip for the semiconductor DUT with grease;
calculating the junction-to-case thermal resistance through using the first transient cooling curve and the third transient cooling curve.

2. The method according to claim 1, wherein the step of calculating the junction-to-case thermal resistance comprises:
calculating a first transient thermal impedance curve according to the first transient cooling curve and a second transient thermal impedance curve according to the third transient cooling curve;
calculating a separation curve according to the first transient thermal impedance curve and the second transient thermal impedance curve;
calculating the junction-to-case thermal resistance according to the separation curve through using a separation criterion.

3. The method according to claim 2, wherein the first transient thermal impedance curves and the second transient thermal impedance curve are calculated through using the following formulas:
$${Z}_{th - dry} = \frac{{T}_{dry 1} ( t ) - {T}_{1}}{{P}_{dry}} , \\ {Z}_{th - tim} = \frac{{T}_{tim 2} ( t ) - {T}_{2}}{{P}_{tim}}$$
wherein Z_{th-dry} is the first transient thermal impedance curve;
T_{dry1}(t) is the first transient cooling curve;
T₁ is a temperature of the constant temperature cold plate when measuring the first transient cooling curve;
P_{dry} is a first heating power measured in the step of measuring the first transient cooling curve;
Zₜₕ₋ₜᵢₘ is the second transient thermal impedance curve;
Tₜᵢₘ₂(t) is the third transient cooling curve;
T₂ is the temperature of the constant temperature cold plate when measuring the third transient cooling curve; and
Pₜᵢₘ is a second heating power measured in the step of increasing the temperature of the constant temperature cold plate and measuring the third transient cooling curve.

4. The method according to claim 3, wherein the step of calculating the separation curve comprises performing logarithmic transformation on time t, namely letting z=In(t), a(z)=Zₜₕ(t), and hence getting a_{dry}(z)=Z_{th-dry}(t) and aₜᵢₘ(z)=Zₜₕ₋ₜᵢₘ(t), and the separation curve is expressed as follows:
δ=Δ(da/dz)/Δθ
wherein Δ(da/dz)=da_{dry}/dz−dzₜᵢₘ/dz, δ is a separation function for the separation curve, da_{dry}/dz is a derivative of the first transient thermal impedance curve Z_{th-dry} with respect to the logarithmic time z, daₜᵢₘ/dz is a derivative of the second transient thermal impedance curve Zₜₕ₋ₜᵢₘ with respect to the logarithmic time z and Δθ is a difference between steady state thermal resistances with and without grease.

5. The method according to claim 4, wherein the separation criterion is a ε-curve equation, ε=0.045 W/° C.θ_{JC}+0.003, and a intersection of the ε-curve equation ε=0.0045 W/° C.θ_{JC}+0.002 and the separation curve δ=Δ(da/dz)/Δθ gives the value of the junction-to-case thermal resistance θ_{JC}.

6. The method according to claim 1, wherein the step of measuring the first transient cooling curve comprises:
fixing the semiconductor DUT on the constant temperature cold plate without grease, wherein the constant temperature cold plate having a temperature of T₁;
applying a first heating current to the chip for the semiconductor DUT;
measuring a first heating power as P_{dry};
switching off the first heating current when reaching a heat balance, the chip for the semiconductor DUT cooling down from a first initial temperature to the temperature of T₁, and
measuring the first transient cooling curve T_{dry1}(t) in the cooling process, calculating the temperature variation ΔT₁ of the first transient cooling curve through using the following formula:
ΔT₁=the first initial temperature −T₁

7. The method according to claim 6, wherein the step of measuring the second transient cooling curve comprises:
maintaining the temperature of the constant temperature cold plate at T1,
applying grease on a bottom surface of the semiconductor DUT,
applying a second heating current to the chip for the semiconductor DUT, wherein the second heating current has the same magnitude and duration as the first heating current,
switching off the second heating current when reaching a heat balance, the chip for the semiconductor DUT cooling down from a second initial temperature to the temperature of T1, and
measuring the second transient cooling curve Tₜᵢₘ₁(t) in the cooling process, and calculating the temperature variation ΔT₂ of the second transient cooling curve through using the following formula:
ΔT₂=the second initial temperature −T₁

8. The method according to claim 7, wherein the difference ΔT is calculated as:
ΔT=ΔT₁−ΔT₂
wherein ΔT is the difference between the temperature variation of the first transient cooling curve and the temperature variation of the second transient cooling curve, ΔT₁ is the temperature variation of the first transient cooling curve, and ΔT₂ is the temperature variation of the second transient cooling curve.

9. The method according to claim 8, wherein the step of increasing the temperature of the constant temperature cold plate by the difference ΔT and measuring the third transient cooling curve of the chip for the semiconductor DUT with grease comprises:
setting a temperature of the constant temperature cold plate to T₂, wherein T₂=T₁+ΔT,
applying a third heating current to the chip for the semiconductor DUT, wherein the third heating current has the same magnitude and duration as the first heating current,
measuring a second heating power as Pₜᵢₘ,
switching off the third heating current when reaching a heat balance and the chip for the semiconductor DUT cooling down to the temperature T₂, and
measuring the third transient cooling curve Tₜᵢₘ₂(t) in the cooling process.
